(19) United States
(12) Patent Application Publication
(10) Pub. No.: US 2025/0016829 A1
(43) Pub. Date: Jan. 9, 2025

(54) TXOP SHARING INITIATED BY NON-AP STATION

(71) Applicants: Dibakar Das, Hillsboro, OR (US); Javier Perez-Ramirez, North Plains, OR (US); Laurent Cariou, Milizac (FR); Dave A. Cavalcanti, Portland, OR (US); Dmitry Akhmetov, Hillsboro, OR (US)

(72) Inventors: Dibakar Das, Hillsboro, OR (US); Javier Perez-Ramirez, North Plains, OR (US); Laurent Cariou, Milizac (FR); Dave A. Cavalcanti, Portland, OR (US); Dmitry Akhmetov, Hillsboro, OR (US)

(21) Appl. No.: 18/754,252

(22) Filed: Jun. 26, 2024

Related U.S. Application Data
(60) Provisional application No. 63/525,579, filed on Jul. 7, 2023.

(51) Int. Cl. H04W 74/0816; H04W 74/08; H04W 84/12

(52) U.S. Cl. CPC H04W 74/0816; H04W 74/0866; H04W 84/12

(57) ABSTRACT

A non-access point station (STA1) configured for transmission opportunity (TXOP) sharing operations in a wireless local area network (WLAN) may allocate time in a TXOP obtained by the STA1 to an access point station (AP) or another non-AP STA (STA2) using a Multi-User Request-To-Send Transmission TXOP sharing (MU-RTS TXS) trigger frame subvariant.

### PRIORITY CLAIM

This application claims priority under 35 U.S.C. 119 (e) to U.S. Provisional Patent Application Ser. No. 63/525,579, filed Jul. 7, 2023 [reference number AF3868-Z] which is incorporated herein by reference in its entirety.

### TECHNICAL FIELD

Embodiments pertain to wireless communications.

### BACKGROUND

One issue with the performance of wireless communication systems is scenarios where multiple devices interact through a shared access point (AP). In such environments, the efficient management of data transmission opportunities, or a Transmission Opportunity (TXOP), is a challenge due to the varying demands of different devices and applications. These systems often need to handle a mix of devices with differing capabilities and requirements, which can lead to congestion and suboptimal utilization of the available communication channels. The coordination between devices for channel access is a common issue, with the goal generally being to maintain smooth and efficient communication across the network.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6A illustrates an example topology with two STAs connected via an infra-AP on the same channel, in accordance with some embodiments.

FIG. 6B illustrates an example topology with two wifi-8 STAs connected to a legacy AP, in accordance with some embodiments.

FIG. 7A is an example of a non-AP STA sharing its obtained TXOP through an MU-RTS TF variant with its associated AP for forwarding UL traffic to another STA, in accordance with some embodiments.

FIG. 7B is an example of a non-AP STA giving allocation piggybacked in an UL data frame to its associated AP for forwarding traffic to another STA, in accordance with some embodiments.

FIG. 7C is an example of a STA-1 allocating time in a Ctrl frame to another STA-2 for the latter to transmit UL data, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In accordance with embodiments, a non-access point station (STA1) configured for transmission opportunity (TXOP) sharing operations in a wireless local area network (WLAN) may allocate time in a TXOP obtained by the STA1 to an access point station (AP) or another non-AP STA (STA2) using a Multi-User Request-To-Send Transmission TXOP sharing (MU-RTS TXS) trigger frame subvariant. These embodiments as well as other are described in more detail below.

Transmission opportunity (TXOP) sharing is a mechanism that helps keep things running smoothly. TXOP, grants a device permission to transmit data for a specific duration. With TXOP sharing, a device can now transmit its data without interruption for a predetermined time. If the device with the TXOP realizes that it doesn't have much data to send, it can share its TXOP. By sharing the TXOP, devices can make the most of their airtime. The device with the TXOP pass can grant a portion of its allocated time to another device, allowing it to transmit its data. This sharing mechanism helps improve overall network efficiency and reduces latency. It's particularly useful in scenarios where some devices have shorter data packets to transmit, while others have longer ones. By sharing the TXOP, the devices with shorter packets can quickly take their turn, without having to wait for a long TXOP duration to expire.

TXOP sharing promotes fairness, reduces waiting times, and ensures that every device gets a chance to be heard. It's like a well-orchestrated conversation, where everyone gets their moment to shine. While TXOP sharing has its benefits, there are some issues. One of the problems with TXOP sharing is the potential for abuse. For example, a device that constantly demands a share of the TXOP, even when it doesn't have much data to send. Another issue arises when the device sharing the TXOP doesn't accurately estimate the time needed by the recipient device. This can cause delays and disrupt the carefully planned schedule of transmissions. Moreover, TXOP sharing can introduce complexities in network management. The access point, acting as the moderator, needs to keep track of who has the TXOP pass and for how long. The overhead of coordination and communication can put additional strain on the network. Compatibility issues can also arise when devices from different manufacturers or with different capabilities try to engage in TXOP sharing. Furthermore, TXOP sharing can impact the overall quality of service (QOS) in the network. For example, a device with time-sensitive data, like a video stream, shares its TXOP with a device transmitting less critical information. The video stream may suffer from delays or interruptions, affecting the user's viewing experience. Balancing the QoS requirements of different devices while allowing TXOP sharing can be a delicate dance.

The described examples focus on enhancing the performance of wireless communication systems, particularly in environments where multiple devices communicate through a shared access point (AP). These examples address the management of data transmission opportunities, using TXOPs, in scenarios involving devices with varying capabilities and performance requirements.

In some examples, the technology involves scenarios where two Station (STA) devices are connected via an infra-AP on the same channel. One STA might be a Virtual Reality Head-Mounted Display (VR HMD), and the other could be an edge server. These devices, operating in conjunction, are engaged in running a VR session. The primary concern in such a setup is the end-to-end latency of data transmission, which is crucial for maintaining the quality of the VR experience.

Another scenario described involves a WiFi-8 STA connected to a legacy infra-AP, with another high compute WiFi-8 STA nearby. In this setup, the legacy AP struggles to enhance channel access for either STA. However, the presence of WiFi-8 capabilities opens up possibilities for these STAs to assist each other in improving their channel access opportunities.

The described examples propose solutions where a non-AP STA shares its obtained TXOP with another device to facilitate data transmission. Specifically, for the first scenario, a non-AP STA shares its TXOP with an infra-AP, which then uses this opportunity to forward the STA's uplink (UL) traffic to the destination STA. This sharing mechanism is aimed at improving the end-to-end latency critical for applications like VR.

In the second scenario, a WiFi-8 non-AP STA shares its obtained TXOP with another WiFi-8 STA. This arrangement allows the second STA to deliver packets with higher reliability, addressing the UL latency issues that might arise due to the limitations of the legacy AP.

The technical mechanisms for sharing TXOP involve various methods of time allocation and data transmission signaling. In one example, a non-AP STA allocates time in its obtained TXOP to its associated AP through a control frame, such as a Multi-User Request-To-Send (MU-RTS) TXOP Sharing (TXS) frame variant. This frame may include specific fields reserved or set to particular values, such as the Association Identifier (AID), which is typically not allocated by the AP itself.

Furthermore, the allocation of TXOP might be piggybacked in an uplink data frame transmitted by the non-AP STA to the AP. This data frame could contain additional signaling specifying the urgency or deadline of the frame, which informs the AP about the priority of the data being transmitted.

In some examples, the non-AP STA specifies that the allocation is for the AP to forward traffic to a specific destination STA. This can be signaled in the Destination Address (DA) field of the management frame. Additionally, the non-AP STA might include frame signaling allocation before sending an uplink Physical Protocol Data Unit (PPDU), allowing the AP to prepare in advance for forwarding the received frame immediately after its reception.

Alternatives to these methods include scenarios where the AP may not use the allocation, in which case the time is returned back to the TXOP owner. This could be determined by the TXOP owner STA observing the medium to be idle for a predetermined duration or not receiving a confirmation to the frame signaling an allocation.

In another example, a client device-1 allocating time to a non-AP STA may give time allocation to another non-AP STA in a similar manner as an unassociated AP gives time allocation to another unassociated AP in multi-AP coordination schemes. This is facilitated through a control frame, and an AID is assigned by the allocating STA using a management frame exchange, which could also be used to signal the traffic parameters the allocation will be used for.

These technical details illustrate the various ways in which the described examples manage TXOP sharing among devices in wireless communication systems, aiming to enhance the efficiency and reliability of data transmissions in complex network environments.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitry 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHZ, 2.4 GHZ, 5 GHZ, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

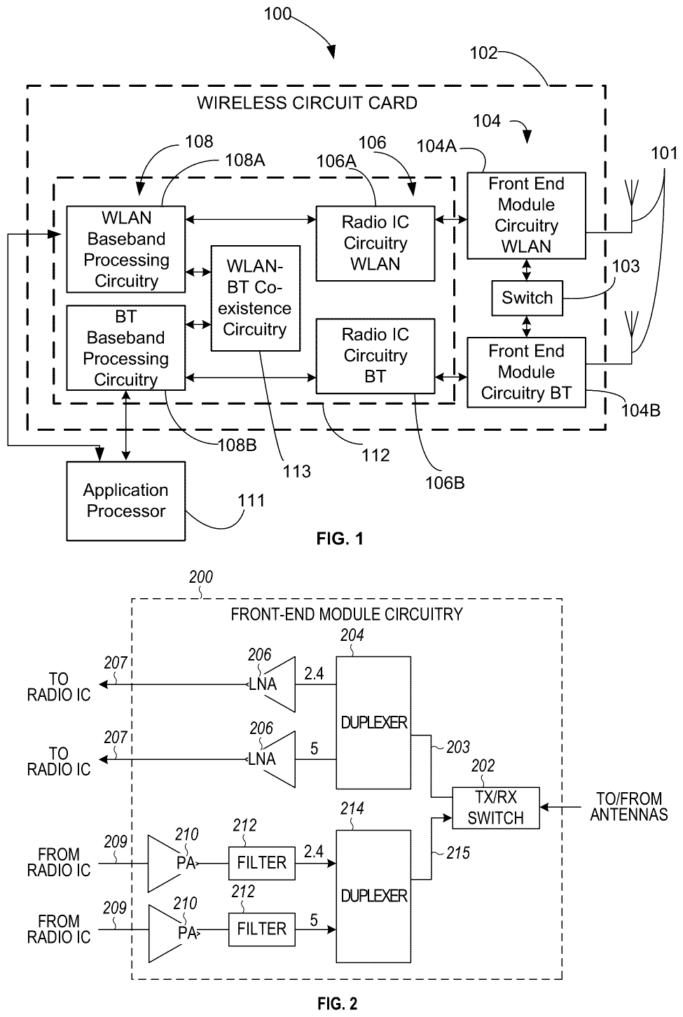

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

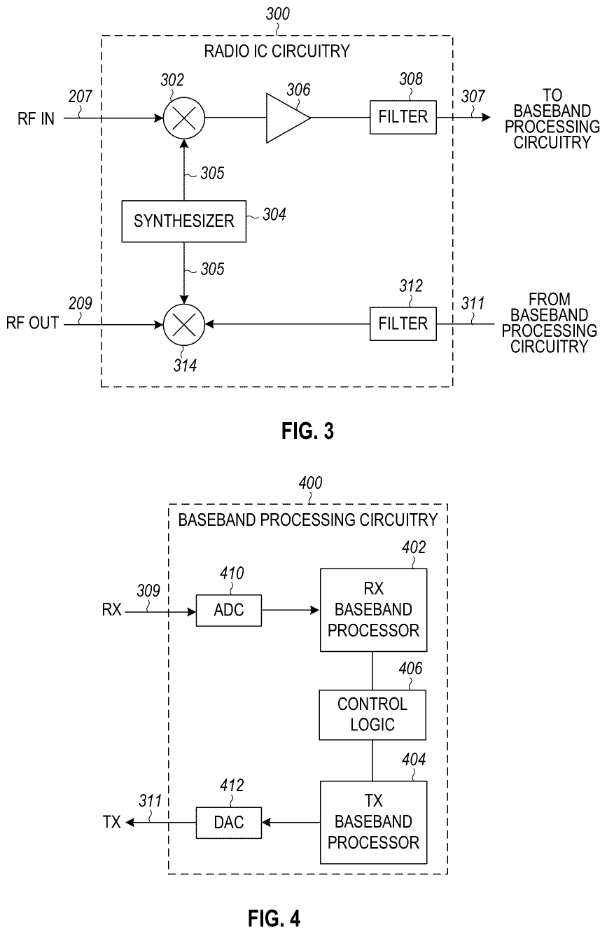

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

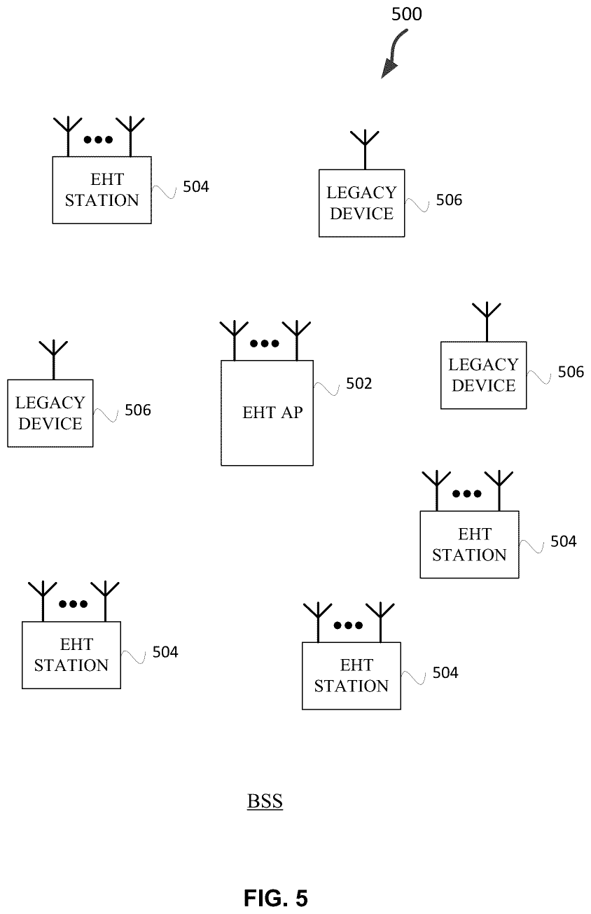

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHZ, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHZ OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) an AP 502 may operate as a primary station which may be arranged to contend for a wireless medium (e.g., during a contention period) to receive exclusive control of the medium for a control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement. Some embodiments are directed to an apparatus of a STA configured for operation in a WLAN comprising processing circuitry and memory. In some embodiments station 504 may be a “group owner” (GO) for peer-to-peer modes of operation. A wireless device may be a station 504 or an AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards.

AP and STA may refer to access point 502 and/or station 504 as well as legacy devices 506.

In some embodiments, the AP and STAs may communicate in accordance with one of the IEEE 802.11 standards. IEEE Std 802.11-2020, IEEE P802.11ax/D8.0, October 2020, IEEE P802.11REVmd/D5.0, IEEE P802.11be/D3.0, January 2023 and IEEE P802.11-REVme/D1.3 are incorporated herein by reference in their entireties.

Improving latency performance especially for interactive applications like extended reality (XR) is a key objective of ultra-high reliability (UHR) (i.e., IEEE 802.11bn). Accordingly, there are several techniques being discussed improve channel access at STAs requiring low latency such as multi-AP coordination that involves a way for one AP sharing its TXOP with another AP. In the EHT timeframe we also have defined Triggered P2P that involves an infra-AP allocating time to a non-AP STA for P2P transmissions. Other than those two topologies, there are some topologies that are not covered by the above schemes.

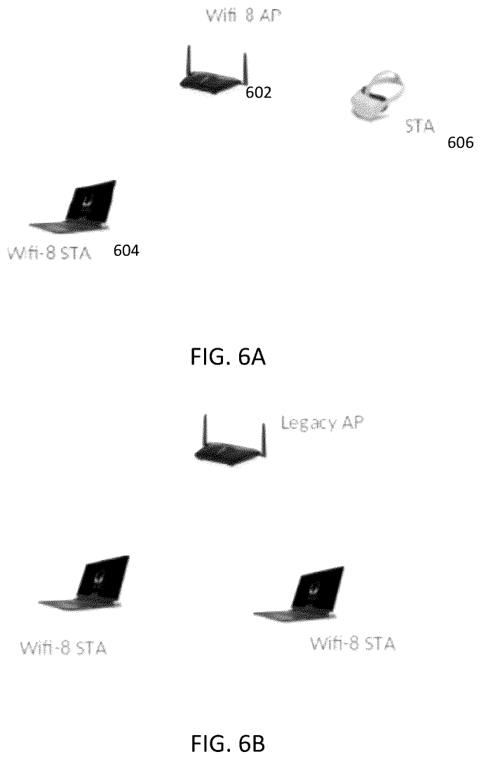

In one topology, illustrated in FIG. 6A, two STAs connected via an infra-AP on the same channel. For example, one STA could be an VR HMD while the other is an edge server as shown in FIG. 6A that together are running a VR session. In this case the main KPI is end-to-end latency. However, current solutions defined in wifi-7 mainly concerns with improving single link channel access. FIG. 6A illustrates an example of a topology with two STAs connected via an infra-AP on the same channel.

In another topology, illustrated in FIG. 6B, Wifi-8 STA associated to a legacy infra-AP with another high compute wifi-8 STA being present nearby. In this case, the legacy AP is not able to improve channel access for either STA. However, being wifi-8 capable, there is an opportunity for the two STAs to assist each other's channel access opportunities. FIG. 6B illustrates an example of a topology with two wifi-8 STAs connected to a legacy AP.

For topology in FIG. 6A, embodiments disclosed herein provide that a non-AP STA shares its obtained TXOP with an infra-AP to forward its UL traffic to the destination STA. For topology in FIG. 6B, embodiments disclosed herein provide that a Wifi-8 non-AP STA device shares its obtained TXOP with another wifi-8 STA so that the latter can deliver packets with high reliability. These embodiments provide for an end-to-end latency for the cases illustrated in FIG. 6A and the UL latency for the cases illustrated in FIG. 6B. By sharing the obtained TXOP in both cases the allocated STA can get additional channel access opportunities in presence of congestion.

In accordance with these embodiments, a non-AP STA device allocates time in an obtained TXOP to its associated AP. In accordance with these embodiments, a non-AP STA-1 or a Mobile AP collocated with a non-AP STA allocates time in an obtained TXOP to another non-AP STA-2 in its range that is associated with an infra-AP, where STA-1 and STA-2 need not be associated to same infra-AP.

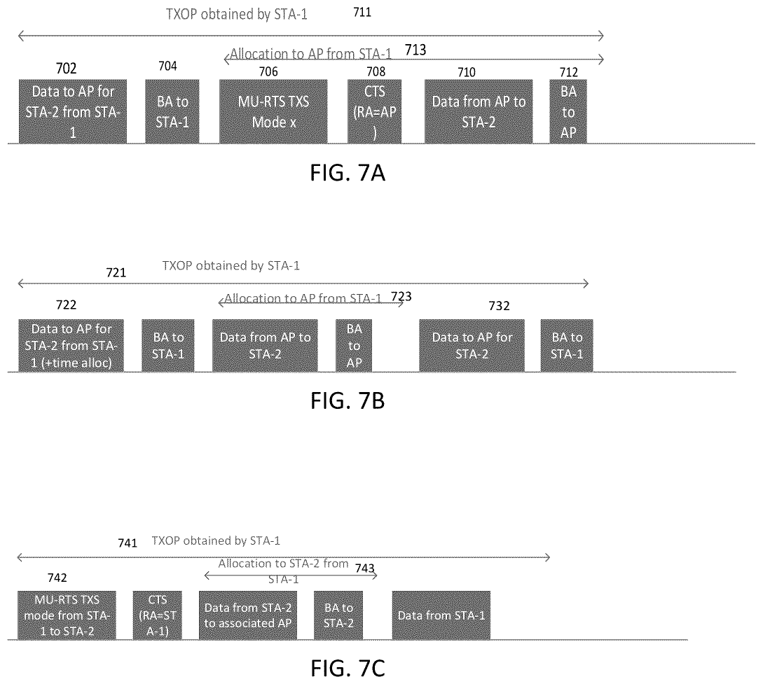

In some embodiments, a non-AP STA gives time allocation in a Ctrl frame (e.g., MU-RTS TXS frame subvariant) transmitted during its obtained TXOP an example of which is shown in FIG. 7A. Note: the AID field may be reserved or set to a specific value (e.g., defined in spec or known at association) if a Trigger frame is used since the AP typically does not allocate any AID to itself. FIG. 7A illustrates an example of a non-AP STA sharing its obtained TXOP through an MU-RTS TF variant with its associated AP for forwarding UL traffic to another STA.

In some embodiments, a non-AP STA gives time allocation in a Qos Data frame (e.g., in a field in the MAC header such as A-Ctrl) transmitted during its obtained TXOP to the AP an example of which is shown in FIG. 7B. The Data frame may further contain signaling specifying the urgency/deadline of that frame. FIG. 7B illustrates an example of a non-AP STA giving allocation piggybacked in an UL data frame to its associated AP for forwarding traffic to another STA.

In some embodiments, the non-AP STA may specify that the allocation is for the AP to forward traffic to a specific destination STA (e.g., signaled in the DA field). In some embodiments, the additional information signaling urgency of packet delivery may be specified by the non-AP STA in a Mgt frame. In some embodiments, the STA may include the frame signaling allocation before sending a UL PPDU so that the AP has time to prepare ahead about forwarding the received frame right after receiving it.

In some embodiments, the AP may not use the allocation in which case the time is returned back to the TXOP owner. This may be determined in one or more of the following ways:
The TXOP owner STA observes medium to be idle for TBD duration (e.g., PIFS) after the last frame transmission to the AP.
The TXOP owner STA does not get a confirmation to the frame signaling an allocation (e.g., a CTS frame sent in response to a MU-RTS frame variant).
The TXOP owner STA gets explicit signaling from the AP returning unused time.

In some embodiments, the AP uses the allocation right away after SIFS from the last frame from the STA or after a TBD duration. In some embodiments, the STA may set the NAV in its last frame sent to that AP protecting a TBD duration during which the AP can become ready to forward the received UL packets. This time could also be signaled by AP during association or some other negotiation.

In some embodiments, the client device-1 allocating time to a non-AP STA may give time allocation to another non-AP STA in the same way as an unassociated AP gives time allocation to another unassociated AP in multi-AP coordination schemes except the allocation is now to a non-AP STA for UL transmissions. FIG. 7C shows an example of a STA-allocating time in a Ctrl frame to another STA-2 for the latter to transmit UL data.

In some embodiments, when a TF (e.g., MU-RTS frame variant) is used to allocate resources to a non-AP STA, an AID is assigned by the allocating STA using a Mgt frame exchange. The frame exchange could also be used to signal the traffic parameter (e.g., signaled in a QoS Characteristics element) the allocation will be used for.

Some embodiments are directed to a non-access point station (STA1) configured for transmission opportunity (TXOP) sharing operations in a wireless local area network (WLAN). In these embodiments, for the TXOP sharing operations, the STA1 may allocate time in a TXOP obtained by the STA1 an access point station (AP) or another non-AP STA (STA2) using a Multi-User Request-To-Send Transmission TXOP sharing (MU-RTS TXS) trigger frame subvariant. In these embodiments, the STA1 may allocate time in a TXOP obtained by the STA1 to an AP using a MU-RTS TXS frame. In these embodiments, the STA1 may allocate time in a TXOP obtained by the STA1 to another non-AP STA (e.g., STA2) using a MU-RTS TXS frame.

In some embodiments, the STA1 may allocate time in a TXOP obtained by the STA1 to the AP for forwarding data to the STA2 when the STA1 is out of range for direct peer-to-peer (P2P) communication with the STA2, although the scope of the embodiments is not limited in this respect. For example, the STA1 604 (see FIG. 6A) may allocate time in a TXOP obtained by the STA1 604 to an AP 602 for forwarding data to another STA (i.e., STA2 606) when the STA1 604 is out of range for direct peer-to-peer (P2P) communication with the STA2 606. In these embodiments, the STA1 604 may be out of range when a certain QoS level, BER, SNR, latency, etc. is unable to be met (e.g., for a QoS data flow with the STA2 606).

In some embodiments, for the TXOP sharing operations when the STA1 is associated with the AP, during the TXOP 711 (see FIG. 7A), the STA1 may encode data 702 for transmission to the AP for forwarding by the AP to the STA2, the data 702 destined for the STA2. In these embodiments, the STA1 may encode the MU-RTS TXS frame subvariant 706 for transmission to the AP to allocate a remaining portion 713 of the TXOP 711 to the AP, the MU-RTS TXS frame subvariant 706 having a TXOP sharing mode subfield set to a predetermined value (e.g., mode X) to indicate that the MU-RTS TXS frame comprises a trigger frame and that the STA1 is sharing the TXOP 711 with the AP for forwarding traffic.

In these embodiments illustrated in FIG. 7A, since the TXOP sharing mode subfield is set to the predetermined value (e.g., indicating mode X), the AP may interpret the allocation received in the MU-RTS TXS frame subvariant 706 for forwarding traffic to another station (e.g., STA2). In these embodiments, STA1 and STA2 may be too far away (e.g., out of range) for direct P2P communication and therefore STA1 may send data 702 destined for STA2 for forwarding by the AP. In these embodiments, the allocation of a remaining portion of the TXOP acquired by STA1 to the AP, for example, allows the AP to send data directly to STA2 with reduced latency since the AP does not need to perform a channel access procedure to acquire the channel on its own.

In some embodiments, to indicate that the remaining portion of the TXOP is allocated to the AP for the purpose of transmitting data from the AP to the STA2, the STA1 may encode the data 702 destined for the STA2 to have MAC addresses that include a transmitter address (TA) set to a MAC address of the STA1, a destination address (DA) set to a MAC address of the STA2, and a receiver address (RA) set to a MAC address of the AP. The STA1 may also set the TXOP sharing mode subfield of the MU-RTS TXS frame subvariant 706 to the predetermined value to indicate a traffic forwarding mode (e.g., mode X). The STA1 may also set a receiver address (RA) field of the MU-RTS TXS frame subvariant to the MAC address of the STA1 or to a broadcast address. The STA1 may also set an AID field of the MU-RTS TXS frame subvariant 706 to either reserved or to a predetermined value to indicate that the MU-RTS TXS frame subvariant 706 is intended for the AP.

In some embodiments, the STA1 may decode a CTS frame 708 received from the AP (with RA=AP) to acknowledge the allocation of the remaining portion 713 of the TXOP 711 to the AP. In these embodiments, in response to the CTS frame 708, the STA1 may set a NAV of the STA1 to refrain from transmitting during the remaining portion 713 of the TXOP 711.

In some embodiments, for the TXOP sharing operations when the STA1 is associated with the AP, during the TXOP 711 (see FIG. 7B), the STA1 may encode data 722 (see FIG. 7B) for transmission to the AP for forwarding by the AP to the STA2, the data 722 destined for the STA2, the data including a time allocation that allocates a portion 723 of the TXOP 721. In these embodiments illustrated in FIG. 7B, the allocation to the AP from STA1 for use by the AP may be piggybacked in an uplink data frame.

In some embodiments, the data may be encoded in a QoS data frame. In these embodiments, the time allocation may be encoded in a control field (e.g., an A-CTRL field of the MAC header) of the QoS Data frame. In these embodiments, the time allocation may be encoded to indicate that STA2 is a destination station for the QoS Data frame signaled in a Destination Address (DA) field (i.e., the destination address (DA) may be set to a MAC address of the STA2). In these embodiments, the QoS data frame may also be encoded to include a priority (e.g., urgency or deadline) for forwarding to the STA2.

In some embodiments, after the portion 723 of the TXOP 721 allocated by the STA1, during a remaining portion of the TXOP 721, the STA1 may encode additional data 732 to the AP for forwarding to the STA2. In these embodiments, only a portion of the remainder of the TXOP may be allocated to the AP, and the remaining time of the TXOP may be used by the STA1.

In some embodiments, the STA1 may be configured to determine that the remaining portion of the TXOP is unused by the AP by observing if the medium is idle or based on receipt of signalling from the AP indicating unused time in the TXOP. See the example illustrated in FIG. 7B.

In some embodiments, to allocate time in the TXOP obtained by the STA1 to the STA2, the STA1 may encode a trigger frame 742 (see FIG. 7C) to allocate a portion 743 of the TXOP 741 to the STA2 for use by the STA2 for transmitting data to the AP. In these embodiments, the trigger frame 742 may comprise a MU-RTS TXS frame subvariant in which an AID may be assigned by STA1 using a management frame exchange. An example of this is illustrated in FIG. 7C.

Some embodiments are directed to a non-transitory computer-readable storage medium that stores instructions for execution by processing circuitry of a non-access point station (STA1) configured for transmission opportunity (TXOP) sharing operations in a wireless local area network (WLAN). In these embodiments, for TXOP sharing operations, the processing circuitry may configure the STA1 to allocate time in a TXOP obtained by the STA1 to one of an access point station (AP) and another non-AP STA (STA2) using a Multi-User Request-To-Send Transmission TXOP sharing (MU-RTS TXS) trigger frame subvariant.

Some embodiments are directed to an access point station (AP) configured for operating in a wireless local area network (WLAN). In these embodiments, the AP may be configured to decode a Multi-User Request-To-Send Transmission Opportunity sharing (MU-RTS TXS) trigger frame subvariant received from a non-AP station (STA1) for transmission opportunity (TXOP) sharing operations. The MU-RTS TXS frame may indicate that the STA1 is allocating time in a TXOP obtained by the STA1 to either of AP or another non-AP STA (STA2). In these embodiments, the AP may receive a MU-RTS TXS frame indicating that the STA1 is allocating time in a TXOP obtained by the STA1 to the AP using a MU-RTS TXS frame. In these embodiments, the AP may receive a MU-RTS TXS frame indicating that the STA1 is allocating time in a TXOP obtained by the STA1 to another station (STA2) using a MU-RTS TXS frame.

In some of these embodiments, for the TXOP sharing operations when the STA1 is associated with the AP, during the TXOP 711 (see FIG. 7A), the AP may decode data 702 received from the STA1 at the AP for forwarding by the AP to the STA2, the data 702 destined for the STA2. In these embodiments, the MU-RTS TXS frame subvariant 706 may be encoded to allocate a remaining portion 713 of the TXOP 711 to the AP, the MU-RTS TXS frame subvariant 706 having a TXOP sharing mode subfield set to a predetermined value (e.g., mode X) to indicate that the MU-RTS TXS frame comprises a trigger frame and that the STA1 is sharing the TXOP 711 with the AP for forwarding traffic.

In some embodiments, the STA may be a mobile device and may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The antennas may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the mobile device is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a non-access point station (STA1) configured for transmission opportunity (TXOP) sharing operations in a wireless local area network (WLAN), the apparatus comprising: processing circuitry; and memory,
wherein for the TXOP sharing operations, the processing circuitry is to configure the STA1 to allocate time in a TXOP obtained by the STA1 to one of an access point station (AP) and another non-AP STA (STA2) using a Multi-User Request-To-Send Transmission TXOP sharing (MU-RTS TXS) frame subvariant.

2. The apparatus of claim 1, wherein the processing circuitry is to configure the STA1 to allocate time in a TXOP obtained by the STA1 to the AP for forwarding data to the STA2 when the STA1 is out of range for direct communication with the STA2.

3. The apparatus of claim 1, wherein for the TXOP sharing operations when the STA1 is associated with the AP, during the TXOP, the processing circuitry is configured to:
encode data for transmission to the AP for forwarding by the AP to the STA2, the data destined for the STA2; and
encode the MU-RTS TXS frame subvariant for transmission to the AP to allocate a remaining portion of the TXOP to the AP, the MU-RTS TXS frame subvariant having a TXOP sharing mode subfield set to a predetermined value to indicate that the MU-RTS TXS frame comprises a trigger frame and that the STA1 is sharing the TXOP with the AP for forwarding traffic.

4. The apparatus of claim 3, wherein to indicate that the remaining portion of the TXOP is allocated to the AP for transmitting data from the AP to the STA2, the processing circuitry is configured to:
encode the data destined for the STA2 to have MAC addresses that include a transmitter address (TA) set to a MAC address of the STA1, a destination address (DA) set to a MAC address of the STA2, and a receiver address (RA) set to a MAC address of the AP;
set the TXOP sharing mode subfield of the MU-RTS TXS frame subvariant to the predetermined value to indicate a traffic forwarding mode;
set a receiver address (RA) field of the MU-RTS TXS frame subvariant to the MAC address of the STA1 or to a broadcast address; and
set an AID field of the MU-RTS TXS frame subvariant to either reserved or to a predetermined value to indicate that the MU-RTS TXS frame subvariant is intended for the AP.

5. The apparatus of claim 4, wherein the processing circuitry is further configured to decode a CTS frame received from the AP to acknowledge the allocation of the remaining portion of the TXOP to the AP,
wherein in response to the CTS frame, the processing circuitry is configured to set a NAV of the STA1 to refrain from transmitting during the remaining portion of the TXOP.

6. The apparatus of claim 1, wherein for the TXOP sharing operations when the STA1 is associated with the AP, during the TXOP, the processing circuitry is configured to:
encode data for transmission to the AP for forwarding by the AP to the STA2, the data destined for the STA2, the data including a time allocation that allocates a portion of the TXOP.

7. The apparatus of claim 6, wherein the data is encoded in a QoS data frame,
wherein the time allocation is encoded in a control field of the QoS Data frame,
wherein the time allocation is encoded to indicate that STA2 is a destination station for the QoS Data frame signaled in a Destination Address (DA) field; and
wherein the QoS data frame is further encoded to include a priority for forwarding to the STA2.

8. The apparatus of claim 7, wherein after the portion of the TXOP allocated by the STA1, during a remaining portion of the TXOP, the processing circuitry is further configured to encode additional data to the AP for forwarding to the STA2.

9. The apparatus of claim 8, wherein the STA1 is configured to determine that the remaining portion of the TXOP is unused by the AP by observing if a medium is idle or based on receipt of signalling from the AP indicating unused time in the TXOP.

10. The apparatus of claim 1, wherein to allocate time in the TXOP obtained by the STA1 to the STA2, the processing circuitry is configured to:
encode a trigger frame to allocate a portion of the TXOP to the STA2 for use by the STA2 for transmitting data to the AP,
wherein the trigger frame comprises a MU-RTS TXS frame subvariant in which an AID is assigned by STA1 using a management frame exchange.

11. A non-transitory computer-readable storage medium that stores instructions for execution by processing circuitry of a non-access point station (STA1) configured for transmission opportunity (TXOP) sharing operations in a wireless local area network (WLAN), wherein for the TXOP sharing operations, the processing circuitry is to configure the STA1 to allocate time in a TXOP obtained by the STA1 to one of an access point station (AP) and another non-AP STA (STA2) using a Multi-User Request-To-Send Transmission TXOP sharing (MU-RTS TXS) frame subvariant.

12. The non-transitory computer-readable storage medium of claim 11, wherein the processing circuitry is to configure the STA1 to allocate time in a TXOP obtained by the STA1 to the AP for forwarding data to the STA2 when the STA1 is out of range for direct communication with the STA2.

13. The non-transitory computer-readable storage medium of claim 11, wherein for the TXOP sharing operations when the STA1 is associated with the AP, during the TXOP, the processing circuitry is configured to:
encode data for transmission to the AP for forwarding by the AP to the STA2, the data destined for the STA2; and
encode the MU-RTS TXS frame subvariant for transmission to the AP to allocate a remaining portion of the TXOP to the AP, the MU-RTS TXS frame subvariant having a TXOP sharing mode subfield set to a predetermined value to indicate that the MU-RTS TXS frame comprises a trigger frame and that the STA1 is sharing the TXOP with the AP for forwarding traffic.

14. The non-transitory computer-readable storage medium of claim 13, wherein to indicate that the remaining portion of the TXOP is allocated to the AP for transmitting data from the AP to the STA2, the processing circuitry is configured to:
encode the data destined for the STA2 to have MAC addresses that include a transmitter address (TA) set to a MAC address of the STA1, a destination address (DA) set to a MAC address of the STA2, and a receiver address (RA) set to a MAC address of the AP;
set the TXOP sharing mode subfield of the MU-RTS TXS frame subvariant to the predetermined value to indicate a traffic forwarding mode;
set a receiver address (RA) field of the MU-RTS TXS frame subvariant to the MAC address of the STA1 or to a broadcast address; and
set an AID field of the MU-RTS TXS frame subvariant to either reserved or to a predetermined value to indicate that the MU-RTS TXS frame subvariant is intended for the AP.

15. The non-transitory computer-readable storage medium of claim 14, wherein the processing circuitry is further configured to decode a CTS frame received from the AP to acknowledge the allocation of the remaining portion of the TXOP to the AP,
wherein in response to the CTS frame, the processing circuitry is configured to set a NAV of the STA1 to refrain from transmitting during the remaining portion of the TXOP.

16. The non-transitory computer-readable storage medium of claim 11, wherein for the TXOP sharing operations when the STA1 is associated with the AP, during the TXOP, the processing circuitry is configured to:
encode data for transmission to the AP for forwarding by the AP to the STA2, the data destined for the STA2, the data including a time allocation that allocates a portion of the TXOP.

17. The non-transitory computer-readable storage medium of claim 16, wherein the data is encoded in a QoS data frame,
wherein the time allocation is encoded in a control field of the QoS Data frame,
wherein the time allocation is encoded to indicate that STA2 is a destination station for the QoS Data frame signaled in a Destination Address (DA) field; and
wherein the QoS data frame is further encoded to include a priority for forwarding to the STA2.

18. The non-transitory computer-readable storage medium of claim 17, wherein after the portion of the TXOP allocated by the STA1, during a remaining portion of the TXOP, the processing circuitry is further configured to encode additional data to the AP for forwarding to the STA2.

19. An apparatus of an access point station (AP) configured for operating in a wireless local area network (WLAN), the apparatus comprising: processing circuitry; and memory,
wherein the processing circuitry is configured to decode a Multi-User Request-To-Send Transmission Opportunity sharing (MU-RTS TXS) frame subvariant received from a non-AP station (STA1) for transmission opportunity (TXOP) sharing operations, the MU-RTS TXS frame indicating that the STA1 is allocating time in a TXOP obtained by the STA1 to either of AP or another non-AP STA (STA2).

20. The apparatus of claim 19, wherein for the TXOP sharing operations when the STA1 is associated with the AP, during the TXOP, the processing circuitry is configured to:
decode data received from the STA1 at the AP for forwarding by the AP to the STA2, the data destined for the STA2,
wherein the MU-RTS TXS frame subvariant is encoded to allocate a remaining portion of the TXOP to the AP, the MU-RTS TXS frame subvariant having a TXOP sharing mode subfield set to a predetermined value to indicate that the MU-RTS TXS frame comprises a trigger frame and that the STA1 is sharing the TXOP with the AP for forwarding traffic.
